(19) United States
(12) Patent Application Publication
(10) Pub. No.: US 2025/0238657 A1
(43) Pub. Date: Jul. 24, 2025

(54) OIL PIPELINE LEAK DETECTION

(71) Applicant: FLOWSTATE TECHNOLOGIES LLC, Phoenix, AZ (US)

(72) Inventors: Tyler Randall Reece, Casper, WY (US); Brayton John Sanders, Casper, WY (US); Dudley Braden Fitz-Gerald, III, Cheyenne, WY (US)

(21) Appl. No.: 19/175,999

(22) Filed: Apr. 10, 2025

Related U.S. Application Data
(62) Division of application No. 17/169,249, filed on Feb. 5, 2021.
Application No. 17/169,249 is a continuation-in-part of application No. PCT/US19/45120, filed on Aug. 5, 2019.
(60) Provisional application No. 62/716,522, filed on Aug. 9, 2018.

(51) Int. Cl. G06N 3/044; G06N 3/08

(52) U.S. Cl. CPC G06N 3/044; G06N 3/08

(57) ABSTRACT

Computer-implemented methods, systems, and software for detecting leaks, for example, in a pipeline that conveys oil. Embodiments include using software wherein the pipeline can be changed without reconfiguring the software, using data from sensors that watch the pipeline, using different layers within the software, using deep learning, monitoring multiple device types, comparing with a parent deep learning neural network several deep learning layers to determine if there is a leak, using a metamodel to compare data to deep learning results, using line balance, pressure, flow, temperature, density, valve position, pump rpm, motor frequency, and/or event tags, considering: meter maintenance, calibration, and recurrent communication issues, and conducting analysis of device data averages to determine anomalies.

### RELATED PATENT APPLICATIONS

This U.S. patent application is a divisional patent application of, and claims priority to, U.S. patent application Ser. No. 17/169,249 filed Feb. 5, 2021, Pub: 20210216852, published on Jul. 15, 2021, which is a continuation-in-part (CIP) patent application of, and claims priority to, Patent Cooperation Treaty (PCT) patent application PCT/US19/45120, filed Aug. 5, 2019, Publication: WO2020033316, published on Feb. 13, 2020, which claims priority to U.S. Provisional Patent Application: 62716522, filed Aug. 9, 2018. The contents of all three of the priority patent applications are incorporated herein by reference. If there are any conflicts or inconsistencies between this patent application and the incorporated patent applications, however, this patent application governs herein.

### FIELD OF THE INVENTION

This invention relates to systems and methods for detecting leaks, for example, in pipelines, for instance, that transport oil, natural gas, water, or other liquids or gasses. Particular embodiments relate to software and computer implemented methods for detecting leaks. Further, certain embodiments relate to use of artificial intelligence in leak detection.

### BACKGROUND OF THE INVENTION

Various systems and methods for detecting leaks have been contemplated and used, including for pipelines, and including pipelines that transport oil, natural gas, and water. Further, software and computer implemented methods have been used for detecting leaks. Needs and opportunities for improvement exist, however, for improved leak detection systems.

Current leak detection systems for pipelines, for example, are costly and are very-slow to implement. Some systems take six to nine months to install, for example. After the install, if there is a change made to the pipeline, it can take another four to six months to make the changes to the leak detection system. Various previous leak detection systems work off of hydro models which take time to develop and require each section of the pipeline to be modeled with its characteristics. When installing a typical prior art leak detection system, for example, the installation becomes pipeline-segment specific, and if there are any changes on a segment of the pipeline it may take up to six months to redeploy the leak detection system.

Specific leak detection systems and methods, that may provide background for the current invention, are described in U.S. Pat. No. 6,970,808 (e.g., Computational Pipeline Monitoring, computer based, sub networks are analyzed using a modified Hardy Cross algorithm configured to handle unsteady states caused by leaking pipelines, pressure and velocity detected, compares measurements collected by the Supervisory Control & Data Acquisition (SCADA) System, simulated model of the flow in the pipeline, automatic threshold adjustment to optimize the sensitivity/false alarm/response time trade off, wave alert, acoustic and statistical pipeline leak detection models). Further examples include: U.S. Pat. No. 8,677,805 (e.g., leak detection system for a fuel line, controller analysis of data from leak tests); U.S. Pat. No. 7,920,983 (e.g., monitoring a water utility network using flow, pressure, etc., machine learning, statistically analyze data); and U.S. Pat. No. 9,939,299 (e.g., monitoring pressure transients, comparing characteristic features with previously observed characteristic features, which can include pressure, derivative, and real Cepstrum of the pressure transient waveform, similarity thresholds used to filter templates can be learned from training data, a nearest-neighbor classifier that performs best on the training data is chosen from among templates).

Still further examples include: U.S. Pat. No. 5,453,944 (e.g., dividing the pipeline into segments, measuring the liquid flow, Development of an Artificial Intelligence AppCon Factor, false alarms must be avoided, algorithm produces a dimensionless number, suppress a false leak indication); U.S. Pat. No. 9,874,489 (e.g., Water leaks in irrigation systems detected by analysis of energy consumption data captured from utility power meters for water pumps, machine learning algorithms, training process, regression algorithms train Support Vector Machines from known data sets that consist of normalized irrigation cycles in an input vector X and of water measurements taken with traditional methods. A vector of weighted coefficients W will be created among thousands of training examples, and applied to measure water from a pump energy data); and U.S. Pat. No. 6,567,795 (e.g., fuzzy logic based boiler tube leak detection systems, uses artificial neural networks (ANN) to learn the map between appropriate leak sensitive variables and the leak behavior, integrates ANNs with approximate reasoning using fuzzy logic and fuzzy sets, ANNs used for learning, approximate reasoning and inference engines used for decision making. Advantages include use of already monitored process variables, no additional hardware and/or maintenance requirements, systematic processing does not require an expert system and/or a skilled operator, and the systems are portable and can be easily tailored for use on a variety of different boilers). Even further examples include: U.S. Pat. No. 5,557,965 (e.g., detecting leaks in a pipeline in a liquid dispensing system, pressure sensor, leak simulation valve for draining the pipeline to simulate a leak); and U.S. Patent Application Publication 20170221152 (e.g., water damage mitigation estimation method, machine learning, refines algorithms or rules based on training data, implement computationally intelligent systems and methods to learn “knowledge” (e.g., based on training data), and use such learned knowledge to adapt its approaches for solving one or more problems (e.g., by adjusting algorithms and/or rules, neural network, deep learning, convolutional neural network, Bayesian program learning techniques, constraint program, fuzzy logic, classification, conventional artificial intelligence, symbolic manipulation, fuzzy set theory, evolutionary computation, cybernetics, data mining, approximate reasoning, derivative-free optimization, decision trees, soft computing).

Further examples include: U.S. Patent Application Publication 20080302172 (e.g., detecting water and/or gas leaks by monitoring usage patterns, controller uses artificial intelligence); U.S. Patent Application Publication 20070131297 (e.g., fluid leak detector for a double carcass hose, optical sensor, offshore oil load and discharge operations, oil leakage, artificial intelligence or neural network software); and U.S. Patent Application Publication 20130332397 (e.g., leak detection in a fluid network, detecting an anomaly in meter data, flow meters, pressure sensors, machine-learning techniques, training set of data including historical data gathered from various sections of the network). Moreover, further examples include: U.S. Patent Application Publication 20170178016 (e.g., forecasting leaks in a pipeline network, prediction model, predicting a series of pressure measurements, water, oil, compressed gas, high-pressure gas transmission, SCADA, machine-learning techniques to determine a model between a geo-spatial distance, flow-rate, and pressure, temporal delay prediction model, machine learning, gradient boosting, determine a mapping function between a set of features, server); U.S. Patent Application Publication 20170131174 (e.g., pressure sensor, detect leaks, more accurate, confidence levels, machine learning, user feedback, verification of leaks, generation of alerts when leaks are detected, comparison of different leak types, increase the confidence in the nature of the leak, cloud computing, analyze pressure data obtained by pressure sensor, analyze data to perform one or more leak detection techniques, frequency domain, time domain, machine learning, once learned, false positives ignored); and U.S. Patent Application Publication 20140111327 (e.g., detecting a leak in a compressed natural gas (CNG) delivery system of a vehicle, leak detection module, datastore, machine learning algorithm, adaptive neural network, lookup table, contents learned heuristically or pre-calculated).

In various past leak detection systems, a computer simulation or hydraulic model would have to be created for every pipeline segment within a pipeline system. Operators would then have to “tune” that simulation to match each real-world segment. Needs and opportunities for improvement exist, for example, for leak detection systems and methods that can be implemented more quickly, that adapt more quickly to changes in the pipeline, that detect leaks over a greater portion of a pipeline, that are easy to install or use, that do not require special (e.g., pipeline modeling) skill to install, that are reliable, that are inexpensive to make, install, and use, that detect smaller leaks, that avoid false positives, or a combination thereof. Room for improvement exists over the prior art in these and various other areas that may be apparent to a person of ordinary skill in the art having studied this document.

### SUMMARY OF PARTICULAR EMBODIMENTS OF THE INVENTION

This invention provides, among other things, various systems and methods for detecting leaks, including for pipelines, and including for pipelines that transport oil, natural gas, or water. Further, this invention provides, among other things, software and computer implemented methods for detecting leaks. Various embodiments are less costly or are quicker or easier to implement than previous alternatives. Some systems take less time to install, develop, or redeploy, for example, after changes are made to a segment of the pipeline. Still further, various embodiments require less skilled labor to implement, for example, for the development of hydro models or for the modeling of each section of the pipeline with its characteristics. Even further, various embodiments are less pipeline-segment specific.

Various embodiments provide, for example, as an object or benefit, that they partially or fully address or satisfy one or more of the needs, potential areas for benefit, or opportunities for improvement described herein, or known in the art, as examples. Different embodiments simplify the design and installation of leak detection systems, reduce the installed cost of the technology, increase implementation or adaptation efficiency, or a combination thereof, as further examples. Certain embodiments can be implemented more quickly, adapt more quickly to changes in the pipeline, detect leaks over a greater portion of a pipeline, are easier to install or use, do not require special (e.g., pipeline modeling) skill to use, install, or implement, are more reliable, are less expensive to make, install, or use, detect smaller leaks, avoid false positives, or a combination thereof. Various embodiments train an AI or Deep-Learning platform to “understand” the physics, relationships, causes and effects of internal pipe liquid or gas flow. Further, various embodiments avoid or bypass the need to build a computer simulation or model of each and every pipeline segment within a pipeline system.

In a number of embodiments, this means leak detection can be applied to more pipeline segments faster and ultimately more economically since resources to develop and tune computer models for each and every pipeline segment are no longer required. A number of embodiments use existing equipment on the pipeline and use deep learning to reduce the time needed to train and configure a leak detection system.

Certain embodiments include, for example, computer-implemented methods, systems, and software for detecting leaks, for example, in a pipeline that conveys oil. Some embodiments include using software wherein the pipeline can be changed without reconfiguring the software, using data from sensors that watch the pipeline, using different layers within the software, using deep learning, monitoring multiple device types, or a combination thereof. Further, some embodiments include comparing with a parent deep learning neural network several deep learning layers, for example, to determine if there is a leak, using a metamodel to compare data to deep learning results, using line balance, pressure, flow, temperature, density, valve position, pump rpm, motor frequency, and/or event tags, or a combination thereof. Still further, various embodiments include considering: meter maintenance, calibration, and recurrent communication issues, and conducting analysis of device data averages to determine anomalies.

Specific embodiments include, for example, various computer-implemented methods of detecting leaks, for instance, in a pipeline, for example, that conveys a liquid or gas, as examples. In a number of embodiments, the method includes certain acts. Such acts may include, for example, an act of inputting, for example, into a computer system, a first set of data, for instance, acquired from the pipeline, for example, during normal operation (e.g., of the pipeline). Further, in various embodiments, the acts include acquiring a second set of data (e.g., from the pipeline), for instance, while simulating leaks (e.g., from the pipeline), for example, by releasing quantities of the liquid or gas (e.g., from the pipeline), for instance, from multiple locations (e.g., along the pipeline). Still further, in a number of embodiments, the acts include inputting, for example, into the computer system, the second set of data. Even further, various embodiments include an act of training (e.g., the computer system), for example, to detect the leaks (e.g., in the pipeline), for instance, including communicating (e.g., to the computer system) that no leaks existed, for example, while the first set of data was acquired, and, in some embodiments, communicating (e.g., to the computer system) that leaks existed, for example, while the second set of data was acquired.

In some embodiments, the method includes, for example, after inputting (e.g., the first set of data and the second set of data), further training (e.g., the computer system), for instance, by inputting (e.g., into the computer system) a third set of data, for example, acquired from the pipeline, for instance, during operation (e.g., of the pipeline). Further, various embodiments include receiving (e.g., from the computer system) alarms, for example, of suspected leaks (e.g., from the pipeline), communicating (e.g., to the computer system), for instance, whether an actual leak existed, for example, when each alarm (e.g., of the alarms) was indicated. Still further, in particular embodiments, the method includes, for example, after inputting the first set of data and the second set of data, making changes (e.g., to the pipeline), and, in certain embodiments, then further training (e.g., the computer system). In particular embodiments, for example, the training includes, for instance, inputting (e.g., into the computer system) a fourth set of data, for example, acquired (e.g., from the pipeline) during operation (e.g., of the pipeline), for instance, after the changes were made. Even further, in certain embodiments, the training includes receiving (e.g., from the computer system), for example, alarms, for instance, of suspected leaks (e.g., from the pipeline). Even further still, in particular embodiments, the training includes communicating (e.g., to the computer system), for example, whether an actual leak existed, for instance, when each alarm (e.g., of the alarms) was indicated.

A number of embodiments, for example, after inputting the first set of data and the second set of data, include making changes (e.g., to the pipeline). Further, certain embodiments include (e.g., then) further training (e.g., the computer system), for instance, with unsupervised learning, for example, to adapt to the changes that were made. Still further, in various embodiments the method includes using deep learning models, using neural networks, using tanh, or a combination thereof, as examples. Even further, in particular embodiments, the method includes using a sigmoid, for example, to decide what parts, and then, in certain embodiments, using a tanh, for instance, to delimit values. Still further, some embodiments use a tanh layer to create new values, for example, for ones that were selected, and in certain embodiments, update a cell state. Even further still, in some embodiments, the method includes using an activation function, for example, to give outputs Y, using training algorithms, using recurrent neural networks, using loops, for example, in a network's architecture, or a combination thereof.

In various embodiments, the method includes, for example, using software that allows information to persist, for instance, as the software lets information be passed (e.g., from one step of a network to a next step). Some embodiments include using multiple copies of a same network, for example, each passing a message, for instance, to a successor. Further certain embodiments include using Long Short Term Memory (LSTM) RNNs, for example, which learn long-term dependencies. Still further, in particular embodiments the method includes using RNN, for example, that have an activation layer, for instance, in every link of a chain. Even further, in certain embodiments, the method includes four neural network layers, the method includes using pointwise operations, the method includes using vector transfers, or a combination thereof, as examples.

Further specific embodiments include, as examples, computer-implemented method of detecting leaks in a pipeline that transports oil, for instance. In a number of embodiments, for example, the method includes using software for detecting leaks from the pipeline. Further, in various embodiments, the pipeline can be changed, for instance, without reconfiguring the software. Still further, in a number of embodiments, using the software includes using data from sensors, for example, that watch the pipeline. Even further, various embodiments include using different layers within the software, for instance, each comprising deep learning. Further still, many embodiments include monitoring multiple device types, for example, each with its own deep learning neural network, comparing with a parent deep learning neural network several deep learning layers, for instance, to determine if there is a leak, for example, with the computer looking at the several deep learning layers at one time, or a combination thereof. Even further still, various embodiments include using a metamodel, for example, to compare data to deep learning results, using line balance, for instance, to predict a line output, using pressure, monitoring for pressure changes, or a combination thereof. Moreover, a number of embodiments include using flow, monitoring for flow changes, using temperature (e.g., to improve line balance accuracy), using density (e.g., to differentiate between crude types), using valve position (e.g., to monitor for changes), using pump rpm or motor frequency (e.g., to monitor for changes), or a combination thereof. Furthermore, some embodiments include using event tags (e.g., to determine outages or learn device average data frequency or to determine device communication issues), considering meter maintenance or calibration, considering recurrent communication issues (e.g., with devices not associated with a field outage), conducting analysis of device data averages (e.g., to determine anomalies), or a combination thereof.

Additionally, some embodiments include using unsupervised learning (e.g., where deep learning models are able to learn changes to the pipeline system, for example, without programing changes). Further, various embodiments include a live version (e.g., that monitors for leaks in real time), a history version (e.g., that reruns data through deep learning models through multiple layers when looking into leaks, for instance, to see what is causing an alarm), or both. Still further, some embodiments include (e.g., graphically) providing controller feedback, for instance, on false positives, determining size, duration, location, or a combination thereof, of a leak, monitoring electrical power or current, or a combination thereof. In addition, various other embodiments of the invention are also described herein, and other benefits of certain embodiments may be apparent to a person of skill in the art of leak detection.

### BRIEF DESCRIPTION OF THE DRAWINGS

The drawings provided herewith illustrate, among other things, examples of certain aspects of particular embodiments. Various embodiments may include aspects shown in the drawings, described in the specification (including the claims), described in the other materials submitted herewith, known in the art, or a combination thereof, as examples. Other embodiments, however, may differ. Further, where the drawings show one or more components, it should be understood that, in other embodiments, there could be just one or multiple (e.g., any appropriate number) of such components.

FIG. 1 is a graph of an example of a signature of pressure change and imbalance over an interval of time in a pipeline that conveys a liquid or gas;

FIG. 2 is a graph of an example of a signature of pressure change and imbalance over an interval of time in the pipeline of FIG. 1, wherein the pipeline is experiencing a leak;

FIG. 3 is a schematic of an example of a neural network with a single hidden layer, a feed-forward neural network;

FIG. 4 is a plot of a sigmoid function in a neural network, which may be used in the hidden layer of a neural network, in which the steepness of the curve controls the activation rate by a scale parameter that increases the difficulty of activation;

FIG. 5 is an example of an unrolled recurrent neural network;

FIG. 6 is an example of an architecture of a LSTM;

FIG. 7 is an example of various layers of a network showing an input layer, hidden layers, and an output layer;

FIG. 8 is a plot of flow over time in a pipeline;

FIG. 9 is a plot of predicted vs. actual values in a pipeline;

FIG. 10 is a flow chart illustrating an example of a method;

FIG. 11 is a plot of an example of a leak simulation that occurred during a batch transition in which the leak detection system (LDS) was able to identify the leak and raise an alarm within one minute and thirty seconds;

FIG. 12 is a plot of an example of an initial data quality analysis illustrating that input flow rate data frequently returns extremely negative values, which are flagged;

FIG. 13 is a block diagram illustrating an example of data streaming;

FIG. 15 is a plot of an example of a deep learning (DL) imbalance method that can learn complex patterns in the data where there is intermittent flow that results in packing/unpacking behavior in which the DL ongoing imbalance calculation (orange results in bottom plot) is much less disrupted by intermittent operation than is the instantaneous mass imbalance;

FIG. 16 is another plot of an example of a deep learning (DL) imbalance method;

FIG. 17 is a plot of an example of a pressure drop surge response;

FIG. 18 is a block diagram illustrating an example of a leak probability analysis;

FIG. 19 is a block diagram illustrating an example of a technical components in a particular embodiment; and

FIG. 20 is a plot of an example of signal propagation latency between incoming flow rate and outgoing flow rate in a particular embodiment.

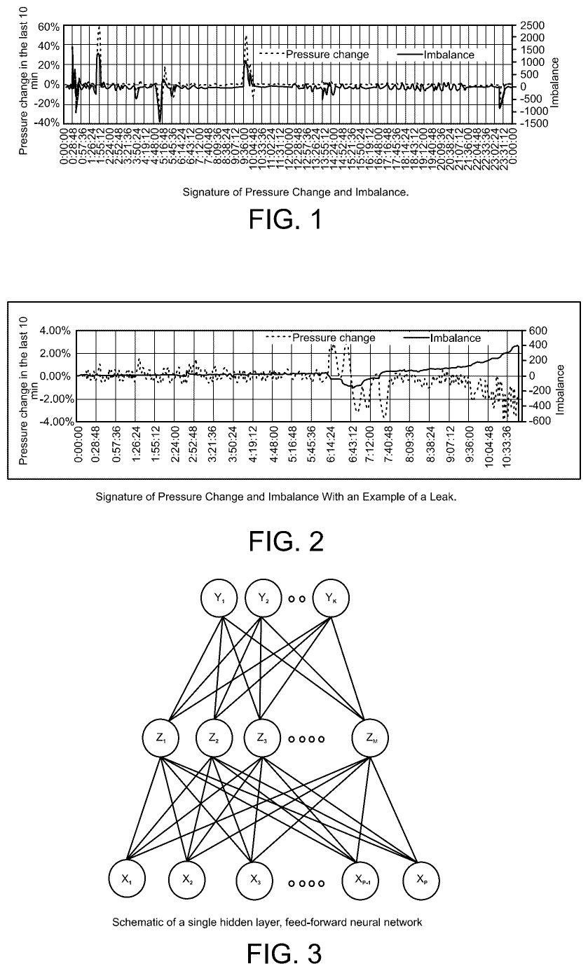

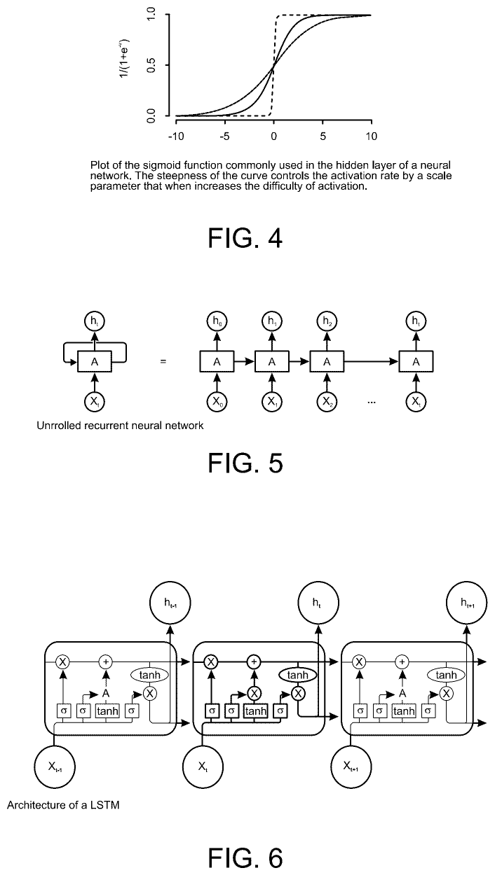

### DETAILED DESCRIPTION OF EXAMPLES OF EMBODIMENTS

This patent application describes, among other things, examples of certain embodiments, and certain aspects thereof. Other embodiments may differ from the examples described in detail herein. Various embodiments include systems and methods for detecting leaks, for example, in a pipeline. The claims describe certain examples of embodiments, but other embodiments may differ. Various embodiments may include aspects shown in the drawings, described in the text, shown or described in other documents that are identified, known in the art, or a combination thereof, as examples. Moreover, certain procedures may include acts such as obtaining or providing various structural components described herein and obtaining or providing components that perform functions described herein. Furthermore, various embodiments include advertising and selling products that perform functions described herein, that contain structure described herein, or that include instructions to perform functions described herein, as examples. The subject matter described herein also includes various means for accomplishing the various functions or acts described herein or that are apparent from the structure and acts described. Further, as used herein, the word “or”, except where indicated otherwise, does not imply that the alternatives listed are mutually exclusive. Still further, unless stated otherwise, as used herein, “about” means plus or minus 50 percent, and “approximately” means plus or minus 25 percent. Further still, where the word “about” is used herein to describe an embodiment, other embodiments are contemplated where “approximately” is substituted for “about”. Similarly, where the word “approximately” is used herein to describe an embodiment, other embodiments are contemplated where “about” is substituted for “approximately”. Moreover, where a numerical value is used herein to describe a parameter of an embodiment, other embodiments are contemplated where the parameter is “about” or “approximately” the numerical value indicated. Even further, where alternatives are listed herein, it should be understood that in some embodiments, fewer alternatives may be available, or in particular embodiments, just one alternative may be available, as examples.

Various embodiments include systems and methods for detecting leaks. Many embodiments are used for pipelines, for example, for pipelines that transport oil, natural gas, or water. Further, various embodiments are or include software or computer implemented methods for detecting leaks. Still further, various embodiments include machine learning, for example, using data from (e.g., existing) sensors, SCADA data, or both. Even further, some embodiments can watch the whole pipeline rather than just segments of the pipeline. Even further still, in some embodiments, the pipeline can be changed without taking months, for example, to reconfigure the system, method, or software. Moreover, certain embodiments include deep learning.

In a number of embodiments, for instance, deep learning makes the system flexible and scalable, for example, quickly. Also, some embodiments include different layers within deep learning, for instance, so several devices can be monitored. In particular embodiments, for example, each device type has its own deep learning neural network, for example, which may watch for issues. If an issue is found, in certain embodiments, a parent deep learning neural network, for instance, compares the results with other deep learning layers, for example, to determine if there is a leak. With a computer looking at several deep learning layers at one time, in some embodiments, faster response to leaks will occur. Further, smaller leaks may be very hard to determine, for example, because of line noise. Line noise, for instance, may cover up the small leaks. In some embodiments, the line noise issue may be reduced, for example, by using multiple deep learning models to determine leaks. In some embodiments, deep learning may not be associated with a certain device type, but may use devices previously on a system, for example.

Some embodiments identify and/or improve devices with poor data quality. As mentioned, various embodiments use deep learning. Still further, some embodiments use a metamodel, for example, with deep learning. Even further, in particular embodiments, metamodels are used to compare data to deep learning results. Further still, certain embodiments include neural networks. Even further still, various embodiments use line balance, for example, to predict the line output. Moreover, some embodiments use pressure, for example, and monitor for relevant pressure changes. Further, some embodiments use flow, for instance, and monitor for relevant and/or correlating flow changes. Still further, some embodiments use temperature, for instance, to improve line balance accuracy. Further still, certain embodiments use density, for example, to differentiate between crude types. Even further, in particular embodiments, valve position is used, for instance, to monitor for relevant and/or correlating changes. Even further still, certain embodiments use pump rpm or motor frequency, for example, to monitor for relevant and/or correlating changes. Moreover, in particular embodiments, connectivity is used, for instance. Some embodiments use event tags, for example, to determine outages, learn device average data frequency, or both, for instance, to determine device communication issues. Furthermore, some embodiments consider meter maintenance and/or calibration. For example, some embodiments consider (e.g., recurrent) communication issues, for instance, with devices not associated with a field outage. Still further, some embodiments conduct analysis of device data averages, for example, to determine anomalies.

Various embodiments use unsupervised learning. Further, in a number of embodiments, deep learning models are able to learn changes on the pipeline system without programing changes. Still further, some embodiments include live versions, for example, that monitor for leaks in real time. Even further, some embodiments include a history version, for instance, that reruns data through deep learning models. Various embodiments are able to rerun data, for example, through the layers, for instance, when looking into leaks. Further still, some embodiments are able to drill down, for example, to see what is causing an alarm. Various embodiments are able to drill into the data to investigate leaks.

Even further still, certain embodiments include controller feedback, for example, on false positives. Moreover, in particular embodiments, findings (e.g., of deep learning) are displayed, for instance, graphically. Various embodiments determine when there is a leak. Further, some embodiments determine size, duration, general location, or a combination thereof, of a leak, as examples. Further still, some embodiments include a density layer and valve position (e.g., not just on or off). Even further, in many embodiments, various hardware may be used. Even further still, some embodiments will work with many different types of hardware or devices. Even further still, in a number of embodiments, deep learning is used that looks at different layers (e.g., line balance, pressure, flow, temperature, density, valve position, and pump operation, for instance, speed, power, current, etc.). Moreover, in some embodiments, the system first predicts what should happen on the pipeline and then matches up the predictions with actuals. Still further, in some embodiments, the AI can look at just a section of the pipeline or the whole pipeline.

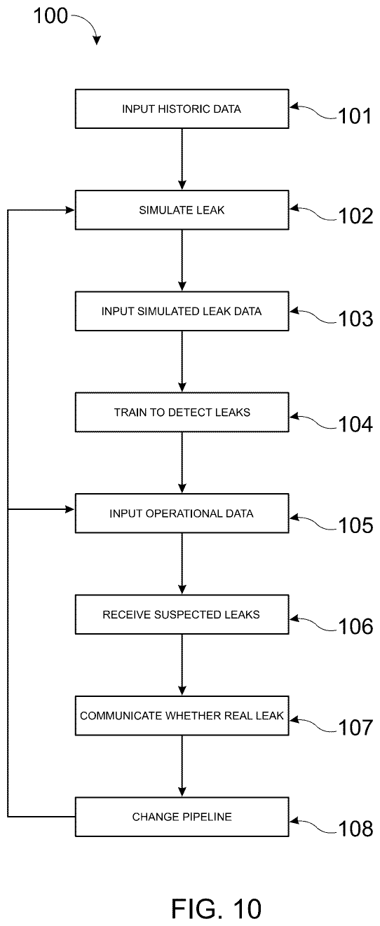

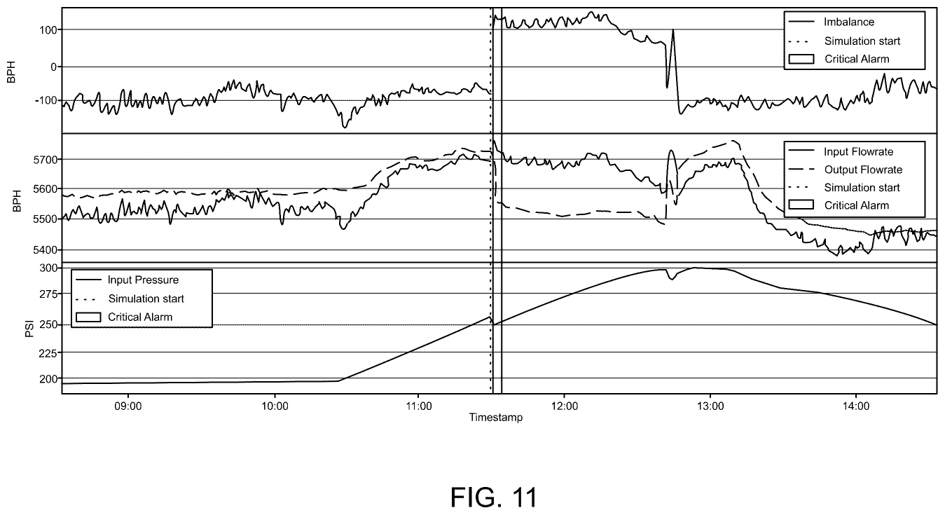

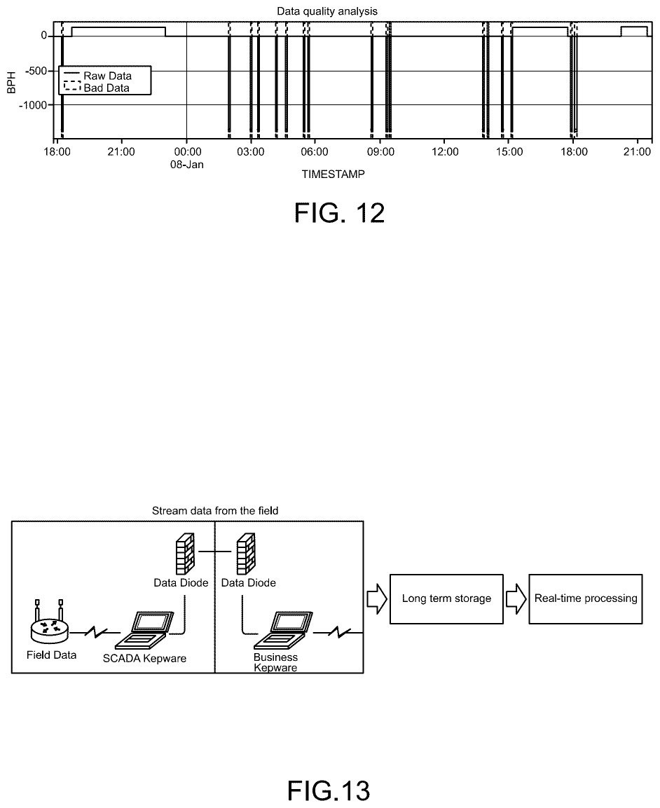

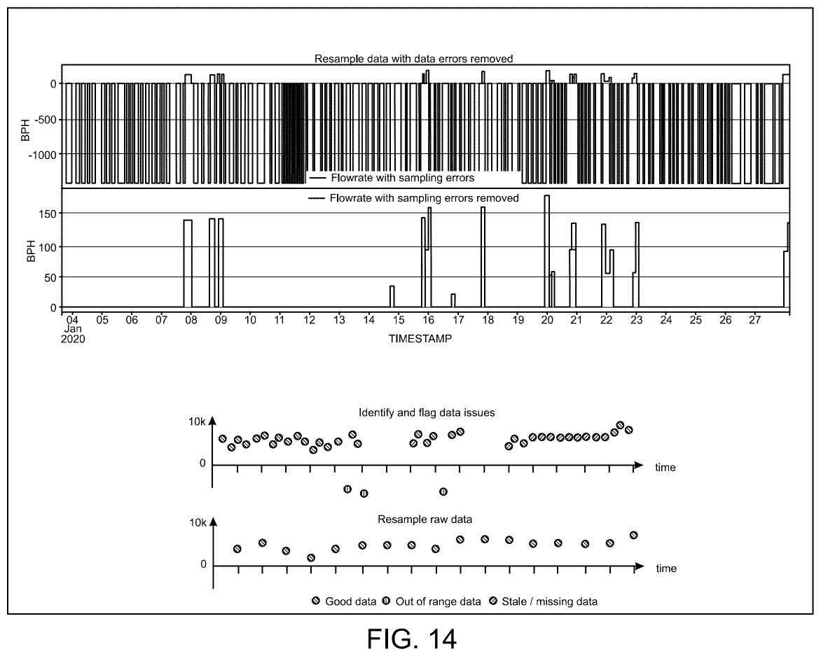

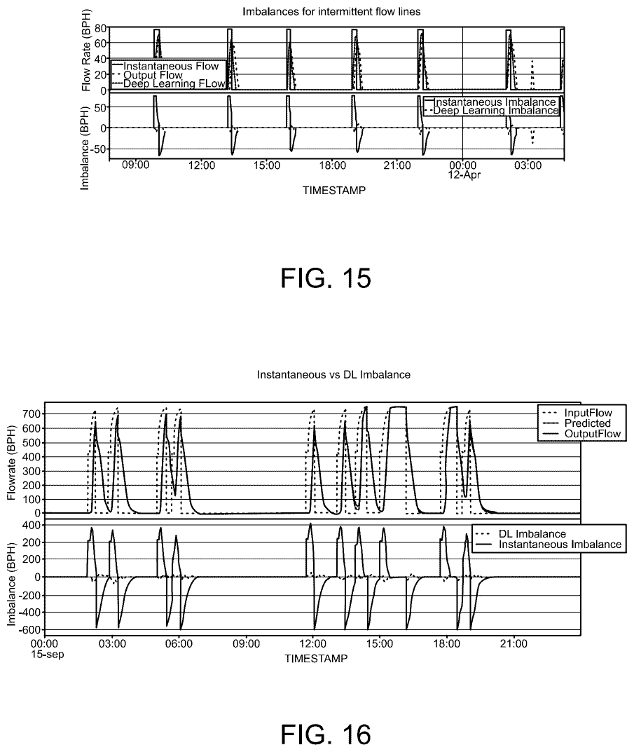

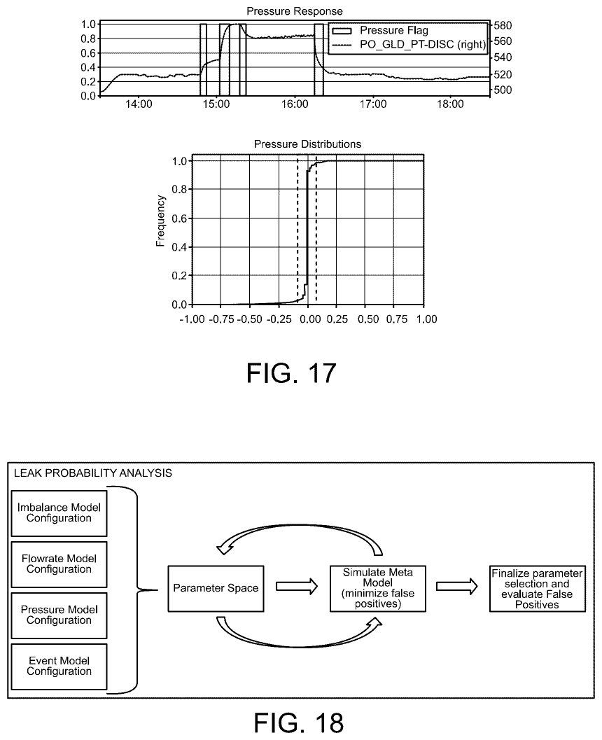

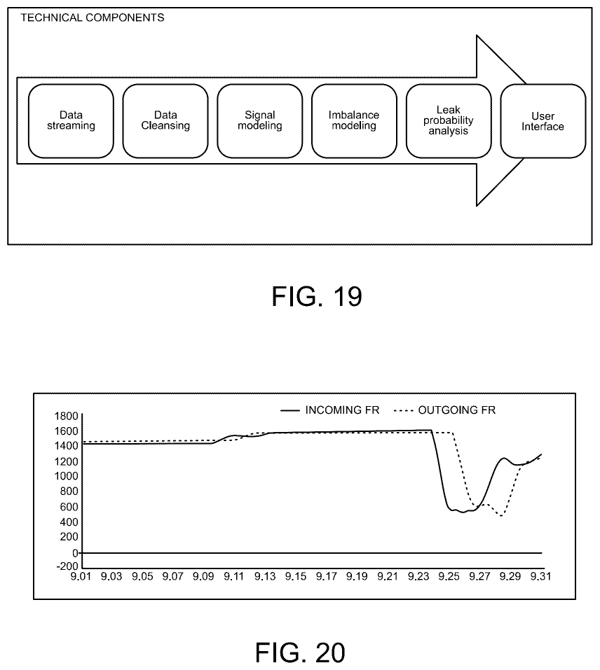

Various embodiments include computer-implemented methods, systems, and software for detecting leaks, for example, in a pipeline, for instance, that conveys a liquid or gas. FIG. 10 illustrates an example of a method, namely, method 100, which is an example of a computer-implemented method of detecting leaks in a pipeline that conveys a liquid or gas. Various embodiments include (e.g., in act 101 of method 100) inputting into a computer system a first set of data, for example, acquired (e.g., from the pipeline) during (e.g., normal or historic) operation (e.g., of the pipeline). Further, various embodiments include acquiring a second set of data (e.g., from the pipeline) while simulating leaks (e.g., in act 102, for example, leaks from the pipeline), for instance, by releasing quantities of the liquid or gas (e.g., from the pipeline), for example, from one or multiple locations (e.g., along the pipeline). In some embodiments, for example (e.g., in act 102), one leak is simulated at one location and data is gathered, and then another leak is simulated at another location and data is gathered. In certain embodiments, still other leaks are simulated at still other locations, for example, one leak being simulated (e.g., in act 102) at a time. In particular embodiments, however, multiple leaks at different locations may be simulated (e.g., in act 102) at the same time. Method 100, and various embodiments, further include inputting, for instance, into the computer system (e.g., in act 103) the second set of data, and training (e.g., in act 104), for example, the computer system, to detect the leaks (e.g., from the pipeline). In some embodiments, the method, for example, act 104, includes communicating, for instance, to the computer system, that no leaks existed while the first set of data (e.g., input in act 101) was acquired. Still further, various embodiments include communicating (e.g., in act 104), for instance, to the computer system, that leaks existed while the second set of data (e.g., input in act 103) was acquired. As used herein, “normal operation” means operation under normal operating parameters without leaks. Further, data that is input (e.g., in act 101, 103, 105, or a combination thereof) may include sensor data, for example, acquired and input in real time or nearly real time, data that has been acquired and stored, or both. In a number of embodiments, for example, historic data (e.g., input in act 101), for example, may have been acquired and stored. Still further, data that is input (e.g., in act 101, 103, or 105) may include data that is automatically fed into the computer, data that is manually entered, or both.

In various embodiments, use of artificial intelligence (AI) allows a leak detection system or leak detection software (e.g., involving method 100) to be added to a segment of a pipeline and put into use in a shorter time that previous alternatives, for example, within weeks. Further, in a number of embodiments when there are changes made to a pipeline (e.g., in act 108), in some embodiments, the AI does (e.g., unsupervised) learning to adapt to the changes that were made. In some embodiments, for example, the system, method (e.g., 100), software, or AI will look at some or all of the same inputs (e.g., input in act 101, 103, 105, or a combination thereof) as humans do, but certain embodiments will be able to evaluate (e.g., all of) the gauges and meters, for instance, throughout the (e.g., whole) pipeline system. Further, in particular embodiments, the system, method (e.g., 100), or software detects or inputs (e.g., input in act 101, 103, 105, or a combination thereof) whether pumps are on, whether a drag reducing agent (DRA) was injected, whether a valve is open or closed, valve position (e.g., open, closed, or position between open and closed), or a combination thereof, as examples.

In a number of embodiments, leak detection software (e.g., used in method 100) uses computer deep learning, for example, to watch for, or determine whether, there is a leak signature on a pipeline (e.g., the leak being reported by the software for act 106). In various embodiments, when there is a leak signature (e.g., received in act 106), the system or method (e.g., 100) provides an indication (e.g., a percent) of confidence (e.g., in act 106), for example, that the signature is a leak. Further, in particular embodiments, the system or method (e.g., 100) reports or displays (e.g., for act 106) why a leak signature was determined, for example, so operators can evaluate the veracity of the conclusion reached by the system, method, or software. Various embodiments include a deep learning model, for example, made of up of multiple or many layers. In various embodiments, the layers are or include (e.g., multiple): flowrates of transported liquid or gas, for example; flowrates of drag reducing agents (DRA); vibration; pressure; density; temperature; motor current (e.g., Amperes), for instance, of pump motors; motor or pump speed or frequency, motor or pump run status (e.g., on or off); comms status; physical locations of transmitters (e.g., GPS coordinates); pipeline mile posts; elevation; equipment alarm status; infrastructure or system alarm status; flow control valve position; pipe diameter; roughness coefficient; or a combination thereof, as examples. In a number of embodiments, Deep Learning layers learn the normal system values (e.g., input in act 101, 105, or both) of the pipeline and when there is a change in any of the items being monitored (e.g., input in act 105), the system or method (e.g., quickly) looks at (e.g., all) other inputs from the (e.g., entire) pipeline, for example, to determine (e.g., and possibly report for act 106) whether there is a leak or a normal pipeline function occurred that caused the change. All feasible combinations are contemplated as different embodiments.

Further, in some embodiments, the people training the model will determine whether there really is a leak and then train the model by inputting or communicating (e.g., in act 107) whether it was actually a leak or not. Still further, in particular embodiments, Deep Learning layers are able to be moved from one pipeline to another, for example, quickly. Even further, in certain embodiments, for example, for each new segment (e.g., of pipeline), the models will (e.g., need to) be trained (e.g., in act 104, 107, or both). Training will include, in some embodiments, for example, feeding live data (e.g., in act 105) into the models from the segment, by simulating (e.g., in act 102) one or more leaks, for example, by turning on one or more valves, or a combination thereof. In some embodiments, training (e.g., in act 104, 107, or both) may also (e.g., need to) occur when changes are made (e.g., in act 108) to a segment of the pipeline. In particular embodiments, the Deep Learning leak detection system, method (e.g., 100), or software, will (e.g., be able to) monitor (e.g., input data in act 103, 105, or both) the (e.g., whole) pipeline system (e.g., at one time) and be able to view sensors (e.g., all at one time) as well. In certain embodiments, for example, by being able to monitor the whole system at one time, Deep Learning will detect leaks faster and can be set up (e.g., trained in at 104, 107, or both) faster than other leak detection systems, as examples.

An unsupervised methodology is used in many embodiments. Some embodiments accept (e.g., every) imbalance alert, for example, or use an imbalance measure, for instance, as a false positive, in the sense of identifying it as an “anomaly” given that there is no line balance, and then determining to what extent that anomaly may be explained by other factors. Thus, in various embodiments, the software identifies anomalies (e.g., for possible reporting for act 106) where there is no line balance, then evaluates whether there is an explanation (i.e., other than a leak) of the anomaly, and then if there is such an explanation, in a number of embodiments, the software determines that the anomaly is not a leak. On the other hand, in various embodiments, if the software finds no explanation for the anomaly, the anomaly is identified as a (e.g., possible) leak, for instance, and the software, in some embodiments, notifies the operator (e.g., for receipt in act 106) of the (e.g., possible) leak. In certain embodiments, if the software can explain or predict an imbalance, it is no longer considered (e.g., for purposes of reporting for act 106) to be an anomaly. Various embodiments better detect a real anomaly, such as a leak, for example, when compared to alternative systems or methods.

Some embodiments involve recurrent neural networks. See, for example, FIG. 5. Various traditional neural networks don't have “memory”, meaning that they have to learn everything from scratch, for example, every single time at every point in time. Various embodiments only use the exact previous information. Having loops in the network's architecture, in some embodiments, allows the information to persist as they let information be passed from one step of the network to the next.

In a number of embodiments, having a loop in the network can be thought of as having multiple copies of the same network, each passing a message to a successor. See, for instance, FIG. 5. Various networks are good for predicting with context, but as the gap of the information grows, RNNs can become unable to learn to connect the information. A special case of RNNs are the Long Short Term Memory ones (LSTM), which are capable of learning long-term dependencies. The repeating module of a standard RNN have a simple structure such as an activation layer, for example, in every link of the chain. The modules in LSTM are different. Instead of having a single neural network layer, for example, there are four. See, for instance, FIG. 6. In this example, each yellow square is a neural network layer, the pink dots are pointwise operations, and the arrows represent vector transfers.

In various embodiments, a key factor of a LSTM is the arrow running at the top of the cell. This is called the cell state. It only has some minor linear interactions allowing information to flow almost unchanged. But LSTM can remove or add information to the cell state by the use of gates composed by a neural network layer with some activation function. This gate describes how much of each component should be let through. In some embodiments, for example, the first gate decides the information to forget or not let through, and is called “forget gate layer”. The next step, in various embodiments, is to decide the information to store in the cell state and may be composed by two parts. First, some embodiments use a sigmoid layer, for example, called the “input gate layer”, for instance, to decide the values to update. Further, in some embodiments, (e.g., then) a tanh layer creates new values for the ones that were selected and update the cell state. In some embodiments, a last step is the “output layer”. Particular embodiments first use a sigmoid to decide what parts and then use a tanh to delimit the values. There are many variants, but this is an often used model.

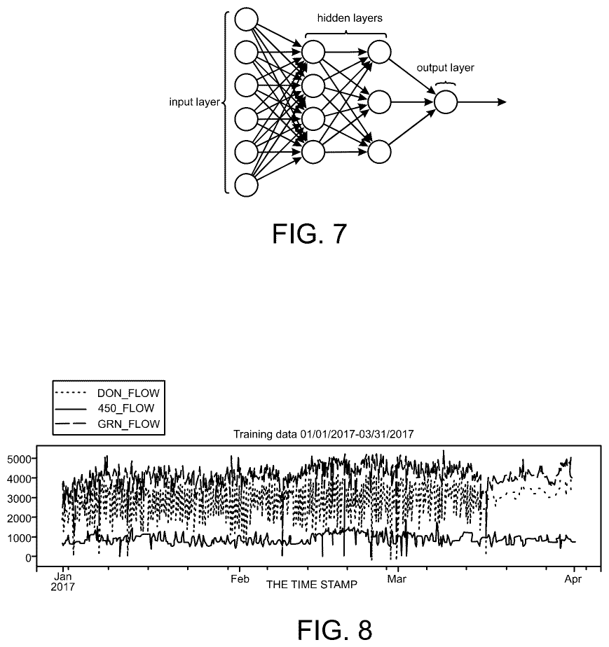

Various embodiments use a multilayer perceptron. In some embodiments, for example, due to the multiple layers in the MLP, a model is capable of solving nonlinear problems which can be the main limitation of the simple perceptron. Various embodiments use a schema of a dense MLP, for example, where all neurons in a layer are connected to all of the following layer's neurons. See, for example, FIG. 7 Further, various embodiments use a dropout. A common problem in various embodiments having deep learning can be over-fitting as neural networks tend to learn very well the relationships in the data as the develop co-dependency of variables, especially when multiple layers and dense (fully connected) networks are used. One way to avoid this, in some embodiments, is by the use of a dropout, for example, which is randomly ignoring neurons with probability 1-p and keeping them with probability p, for instance, for each training stage.

Still further, some embodiments apply deep learning to imbalance prediction. Some embodiments, for example, derive a prediction model for the outflow at EOL given as input the input at 450 and LC1. For example, inputs may be the tag values in LC1 and 450 stations with a final outcome at EOL. In an example, a first model iteration is trained with the data from three months divided in train and test sets with 80-20 proportions. In some embodiments, instead of using the raw data from the time series, the data is processed with a rolling average of 1 minute data with 10 seconds steps, for example, in order to soften the curves and reduce random fluctuations. See, for example, FIG. 8. In various embodiments, the system will allow adjustment of the time, for example, from 1 second to hours if needed.

In some embodiments, for example, to represent the time dependency in a multivariate time series, data is rearranged, for example, to ingest the data as a supervised learning problem. In some embodiments, for example, information is taken from the past 30 minutes in LC1 and 450 to predict the outcome for the current time in EOL. Particular embodiments do feature scaling, for example, because many objective functions don't work properly without it, because convergence is faster, or both. Some embodiments use 10 second steps, there are 6 data points each minute giving a total of 180 for the 30 minutes for LC1 and 180 for 450. Then in this example there are 360 input variables (same as the number of neurons in the input layer) and 1 output variable, being EOL (equal number of output neurons).

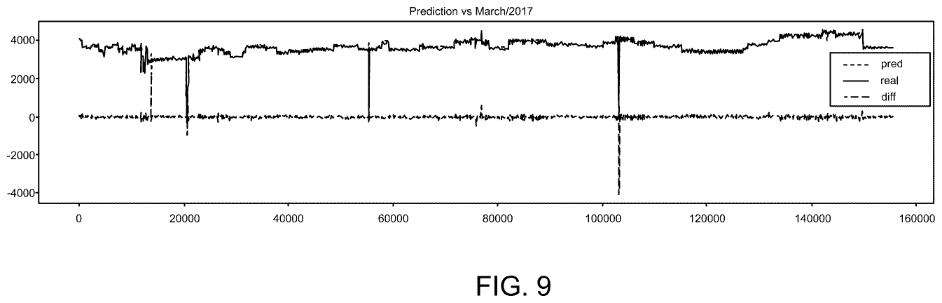

Some embodiments, for example, use a three-hidden layer MLP network, for example, with 180 neurons each, for instance (e.g., hidden-neuron=mean (input layer, output layer) which is roughly 180). Also, some embodiments use a probability dropout of 0.2 between each layer to prevent over-fitting. The prediction in the test set can be as shown in FIG. 9, for example. In various embodiments, a neural network model can give a (e.g., very good) overall forecast, and thus, help to detect a leak if it differs to the real flux by some threshold of time or value. In particular embodiments, for instance, 99.1% of the predicted values lay inside a 3 standard deviations interval and 98% in a 2 standard deviation interval with a Square Root Mean Error of 29.31, that represents barrels per hour. Although this gives a pretty good flux forecast, the model can still be optimized and tested in stress situations.

Various embodiments are or include a computer-implemented method of detecting leaks in a pipeline, for example, that conveys a liquid or a gas. Some embodiments, for example, include at least certain acts. Such acts may include, for example, inputting into a computer system a first set of data, for instance, acquired from the pipeline, for example, during normal operation of the pipeline. Further, in a number of embodiments, the acts may include acquiring a second set of data, for instance, from the pipeline, for example, while simulating leaks from the pipeline, for instance, by releasing quantities of the liquid or gas from the pipeline, for example, from multiple locations along the pipeline. Still further, in various embodiments, the method may include inputting into the computer system the second set of data, and training the computer system, for example, to detect the leaks (e.g., in the pipeline). In some embodiments, for example, thia may include communicating (e.g., to the computer system) that no leaks existed while the first set of data was acquired, and communicating (e.g., to the computer system) that leaks existed while the second set of data was acquired.

Further, certain embodiments include, for example, after inputting the first set of data and the second set of data, further training the computer system, for instance, by inputting (e.g., into the computer system) a third set of data, for example, acquired from the pipeline (e.g., during operation of the pipeline), receiving (e.g., from the computer system) alarms, for instance, of suspected leaks (e.g., from the pipeline), or both. Still further, some embodiments include communicating (e.g., to the computer system) whether an actual leak existed (e.g., when each alarm, i.e., of the alarms, was indicated). Even further, some embodiments include, for instance, after inputting (e.g., the first set of data and the second set of data), making changes (e.g., to the pipeline), and in some embodiments, then further training the computer system. For example, in particular embodiments, such training may include inputting (e.g., into the computer system) a fourth set of data (e.g., acquired from the pipeline), for instance, during operation of the pipeline, for example, after the changes were made. Further still, some embodiments include receiving (e.g., from the computer system) alarms, for example, of suspected leaks, for instance, from the pipeline. Even further still, in particular embodiments, the method includes communicating (e.g., to the computer system), for instance, whether an actual leak existed, for example, when each alarm (e.g., of the alarms) was indicated.

In certain embodiments, for example, after inputting (e.g., the first set of data, the second set of data, or both), making changes (e.g., to the pipeline), (e.g., then) further training (e.g., the computer system), for example, with unsupervised learning, for instance, to adapt to the changes (i.e., that were made), or both. Further, in some embodiments, the quantities (e.g., of the liquid or gas) are released (e.g., from the pipeline) through valves, for example. Still further, in various embodiments, the liquid or gas is or includes oil, natural gas, or water, as examples. Even further, in particular embodiments, the liquid or gas consists essentially of: oil, natural gas, or water. Further still, in some embodiments, the first set of data includes SCADA data, the second set of data includes SCADA data, the third set of data includes SCADA data, or a combination thereof, as examples. Even further still, in various embodiments, the first set of data is collected from the entire pipeline, the second set of data is collected from the entire pipeline, the third set of data is collected from the entire pipeline, or a combination thereof.

In a number of embodiments, the method includes deep learning. For example, in some embodiments, the computer system implements deep learning. Further, in particular embodiments, the computer system implements artificial intelligence. Moreover, in various embodiments, the first set of data the second set of data, the third set of data, the fourth set of data, or a combination thereof, includes whether pumps are on, whether DRA was injected, whether a valve is open or closed, or a combination thereof, as examples. For example, in various embodiments, the computer system implements computer deep learning to watch for, or determine whether, there is a leak signature on the pipeline. In a number of embodiments, for example, when there is a leak signature, the computer system provides an indication of confidence that the signature is a leak, for instance, a percentage of confidence that the signature is a leak. Still further, in certain embodiments, for example, when there is a leak signature, the computer system reports or displays, as examples, why a leak signature was determined, for instance, so operators can evaluate the veracity of the conclusion (e.g., reached by the computer system or method).

In some embodiments, the method includes a deep learning model, for example, made of up of multiple layers, for example, that include flowrates (e.g., of the liquid or gas or of DRA). Further, in particular embodiments the (e.g., multiple) layers include vibration, pressure (e.g., within the pipeline), density, temperature, motor current (e.g., of pump motors) amperage, motor speed, pump speed, motor frequency, motor run status (e.g., on or off), pump run status, comm status, physical locations (e.g., of transmitters, for instance, GPS coordinates, pipeline mile posts, elevation, etc.), equipment alarm status, infrastructure or system alarm status, flow control valve position, pipe diameter, roughness coefficient, or a combination thereof, as examples. In various embodiments, for instance, deep learning layers learn normal system values (e.g., of the pipeline) and when there is a change in any of the items being monitored, the method looks at other inputs (e.g., from the pipeline) to determine whether there is a leak, or whether a normal pipeline function occurred that caused the change.

In a number of embodiments, for example, people training the model determine whether there really is a leak, and then train the model by inputting whether there was actually a leak. Further, in some embodiments, Deep Learning layers are (e.g., able to be) moved, for example, from one pipeline to another, for instance, and then trained (e.g., by feeding data into models, for instance, live data, for example, by simulating one or more leaks, for example, by simulating multiple leaks, for instance, by opening one or more valves. In various embodiments, a modeling process is used to detect pipeline leaks. Further, in particular embodiments, flowmeter readings are taken about every 10 seconds, changes are assumed to propagate at approximately the speed of sound, perturbations are assumed to propagate at approximately the speed of sound, about 1 min time intervals are used as the appropriate scale, about 6 measurements are used for a reasonable degree of smoothing (e.g., while at the same time permitting the associated coarse-grained time series to be responsive to larger changes), or a combination thereof, as examples. Still further, in a number of embodiments, determining a leak alert from a line imbalance includes using magnitude, duration, or both, for example, of the imbalance.

Various methods include activation of an alarm, for example, when a leak is detected. In some embodiments, for instance, there are two types of action, for example, an alarm and a critical alarm. Further, in particular embodiments, an (e.g., any) event corresponding to a given imbalance (e.g., over a certain time period) is (e.g., automatically) contained in the events of the same balance of a longer time period. Still further, in a number of embodiments, unsupervised learning is used. For example, in certain embodiments, there are no recognized leaks in an archiver history and unsupervised learning is used. Still further, some embodiments include accepting (e.g., every) imbalance alert (e.g., in an archiver history) as a false positive (e.g., of a leak). Even further, certain embodiments include determining to what extent an imbalance alert can be explained by factors other than a leak. Further still, various embodiments include using an imbalance measure, for example, to identify an imbalance alert. Certain embodiments include, for instance, explaining imbalances (e.g., where a leak did not exist), for example, to better predict an actual leak. Even further still, in particular embodiments, the method includes predicting imbalances without a leak, for example, to better predict an actual leak.

Some embodiments include using multiple leak detection models. In particular embodiments, for example, the method includes using a baseline model that uses an instantaneous imbalance. Further, certain embodiments include, for example, using the equation:

$$I ( t ) = V ( LC 1 , t ) + V ( 450 , t ) + V ( LC 2 , t ) - V ( EOL , t ) .$$

Still further, some embodiments include using models of (e.g., increasing) sophistication hierarchically. Even further, in particular embodiments, the method includes using models so that CONDITIONS become more multifactorial. Further still, certain embodiments include using a time delay, for example, of an imprint on a flow. Even further still, in some embodiments, the time delay is based on a finite velocity of propagation of a perturbation caused by an event. Moreover, in various embodiments, a time delay is used, for example, that varies as a function of season, that varies as a function of temperature, that varies as a function of product characteristics, that varies as a function of event type, or a combination thereof, as examples.

Moreover, various embodiments include determining a degree of correlation, for example, between line imbalances and events, for instance, that have been determined to be of predictive value (e.g., for leak alarms). In some embodiments, for example, the method includes using that each event type, X, has a degree of correlation with a leak alarm class, C, of the form P (C|X). Further, in particular embodiments, P (C|X) is the probability to see an imbalance leading to an alarm of type C if there was an event of type X in the recent past. Still further, various embodiments include using a performance landscape. Even further, in certain embodiments, the method includes joining together conditions associated with an (e.g., improved) time-delayed imbalance. Further still, in a number of embodiments, the method includes multiple conditions to enhance a predictive value of models. Some embodiments, for example, include identifying alarms as false positives, for instance, by correlating with events that are linked to imbalances. Even further still, certain embodiments include identifying alarms as false positives by correlating with events that are strongly linked to imbalances. Moreover, some embodiments include identifying alarms as false positives by identifying incorrect time matching.

A number of embodiments include using a pressure sub-model. Further, some embodiments include using discrete archiver events, for example, as predictors of imbalances. Further still, certain embodiments use continuous measurement variables, for example, that may change when there is a leak, may be of use as leak alarm predictors, or both. Still further, in particular embodiments, the method includes using when a pump is started (e.g., in the pipeline), using when a pump is stopped (e.g., in the pipeline), using a surge of pressure, using a drop of pressure, using a flow rate, using when a flow rate is set to a higher or lower point, using alignment between flow imbalance and change in pressure, using a comparison of direction of change between flow imbalance and change in pressure, or a combination thereof, as examples. Even further, in some embodiments, the method includes identifying a leak by detecting: more flow coming in to a section than coming out, a drop in pressure in a section, or both. Even further still, certain embodiments include using multiple algorithms.

In some embodiments, the method includes using two thresholds of interest, for example, for pressure change and for imbalance. Further, various embodiments include using a pressure signal in an alarm landscape. Still further, in particular embodiments, the method includes using a level of imbalances, for example, of 50 barrels/hour, for instance, for 2 minutes. Even further, various embodiments include using deep learning models, using neural networks, using nonlinear statistical models, using multi-stage regression, using (e.g., one or more) classification models, using a network diagram, or a combination thereof, as examples. Further still, certain embodiments include using a feature vector Xp, a derived features vector Zm, an output or target measurements Yk, or a combination thereof.

In various embodiments, the method includes using a basic neural network model, for example, with a single hidden layer (Z). Further, in some embodiments, the method includes using derived features Z that are created from linear combinations of original inputs. Still further, certain embodiments include using a target Y, for example, that is modeled as a function of linear combinations of Z. In a number of embodiments, the method includes using a series of functional transformations. Even further, various embodiments include constructing linear combinations of input variables X. Certain embodiments, for example, include using:

$${a}_{m} = {\sum }_{i = 1}^{p} {w}_{mi} {X}_{i} + {w}_{m 0} .$$

In some embodiments, the method includes using parameters, for example, weights, biases, or both. Further, some embodiments include using quantities, for example, that are activations. Still further, certain embodiments include transforming using a differentiable, nonlinear activation function, for example. Even further, some embodiments include using:

Zⱼ=h(aⱼ).

In a number of embodiments, the method includes using a nonlinear function h. Further, in particular embodiments, the method includes using a sigmoidal function. Still further, certain embodiments use a logistic sigmoid. Even further, some embodiments include using tanh. Further still, certain embodiments include using rectifier linear units (ReLU) functions, for example. Even further still, in particular embodiments, the method includes (e.g., linearly) combining Z values, for instance, to give output unit activations, for example:

$${a}_{k} = {\sum }_{j = 1}^{m} {w}_{kj} {Z}_{j} + {w}_{k 0} .$$

In various embodiments, the method includes transforming output unit activations. Further, some embodiments include using an activation function to give outputs Y. Still further, certain embodiments include using error backpropagation. Even further, some embodiments include using training algorithms, for example, for minimization of an error function. Further still, in particular embodiments, the method includes using training algorithms that involve an iterative procedure. Even further still, certain embodiments include using adjustments, for example, to weights, for instance, made in a sequence of steps. Moreover, some embodiments include distinguishing (e.g., two) different stages. Furthermore, some embodiments include evaluating derivatives, for example, of an error function, for instance, with respect to weights.

In particular embodiments, errors propagate backwards through the network. Further, in some embodiments, derivatives are used, for instance, to compute adjustments, for example, to weights. Still further, various embodiments include using an optimization method. Even further, in certain embodiments derivatives are used, for example, to compute adjustments to weights, for instance, by gradient descent. Various embodiments include using recurrent neural networks, using loops (e.g., in the network's architecture), or both. Even further, some embodiments include using software that allows information to persist, for example, as the software lets information be passed from one step of the network to a next step. Further still, some embodiments include using multiple copies of a same network, for instance, each passing a message to a successor.

Various embodiments include using RNNs, for example, Long Short Term Memory (LSTM) ones, for instance, which learn (e.g., long-term) dependencies. Further, in some embodiments, the method includes using RNN that have an activation layer, for example, in every link of a chain. Still further, in particular embodiments, the method includes using different modules, for example, in LSTM. Even further, some embodiments include multiple neural network layers, for example, four neural network layers. Further still, certain embodiments include using pointwise operations, using vector transfers, or both. Even further still, some embodiments include using linear interactions, for example, allowing information to flow, for instance, (e.g., almost) unchanged. Moreover, some embodiments include using a LSTM that removes or adds information, for example, to a cell state, for instance, by the use of gates, for example, composed by a neural network layer, for instance, with an activation function. Furthermore, in particular embodiments, the method includes using gates, for example, that determine how much of each component should be let through. In some embodiments, for example, the method includes: using a forget gate layer, using software that decides information to store in a cell state, using a sigmoid layer (e.g., to decide the values to update), using an input gate layer (e.g., to decide the values to update), using a tanh layer (e.g., to create new values for ones that were selected and update the cell state), using an output layer, or a combination thereof.

In a number of embodiments, the method includes using a sigmoid, for example, to decide what parts, and, in particular embodiments, then using a tanh, for instance, to delimit values. Certain embodiments include using a multilayer perceptron, using a model, for example, that is capable of solving nonlinear problems, using a schema, for instance, of a dense MLP, for example, where all neurons in a layer are connected to all of a following layer's neurons. Further, some embodiments include using a dropout. Still further, certain embodiments include (e.g., randomly) ignoring neurons, for example, with probability 1-p, for instance, and keeping neurons with probability p. Even further, in particular embodiments, the method includes (e.g., randomly) ignoring neurons, for example, with probability 1-p, for instance, and keeping neurons with probability p, for example, for each training stage. Further still, some embodiments include applying deep learning, for example, to imbalance prediction. Even further still, in some embodiments, the method includes using a rolling average, for example, to soften curves, to reduce (e.g., random) fluctuations, or both, as examples. For instance, in particular embodiments, the method includes using a rolling average of 1 minute data with 10 seconds steps.

Some embodiments include using a first model iteration, for example, that is trained with data, for instance, from three months. Further, in some embodiments, the method includes using a first model iteration that is trained with data divided in train and test sets, for example. For instance, certain embodiments include using train and test sets with 80-20 proportions, for example. Still further, some embodiments include using data that is rearranged, for example, to ingest the data, for instance, as a supervised learning problem. Even further, in particular embodiments, the method includes using scaling. In various embodiments, for example, the method includes using (e.g., about) 10 second steps, using (e.g., about) 360 input variables, 1 output variable, or both, using a (e.g., three-) hidden layer MLP network, using (e.g., about) 180 neurons (e.g., per network or per layer, using a probability dropout of (e.g., about) 0.2 between each layer, or a combination thereof, as examples. Even further still, in a number of embodiments, the method includes: using a probability dropout (e.g., to prevent over-fitting), testing and optimizing a model (e.g., in stress situations), notifying an operator (e.g., of the pipeline), for instance, that there is a leak in the pipeline, fixing a leak in the pipeline, shutting off (e.g., the pipeline), for instance, to reduce leakage (e.g., from a suspected leak), or a combination thereof.

In various embodiments, the method or system includes measuring the data, for example, measuring the first set of data. Further, in a number of embodiments, the method or system includes transmitting the data, for example, to the computer system. For example, in some embodiments, the method or system includes transmitting the first set of data to the computer system. Still further, in various embodiments, the method or system includes shutting off flow, for example, into the pipeline, for instance, when a leak is detected. Even further, in a number of embodiments, the method or system includes fixing a leak, for example, after the leak is detected. Even further still, some embodiments are or include a system, for example, of detecting leaks, for instance, in a pipeline that conveys a liquid or gas, as examples. In a number of embodiments, the system includes at least one computing device. Furthermore, in various embodiments, the system, the at least one computing device, or both, performs a method, for example, described herein.

A number of embodiments are or include a computer program, for example, for detecting leaks, for instance, in a pipeline, for example, that conveys a liquid or gas. In various embodiments, the computer program includes machine readable instructions that, when executed, cause at least one computing device to performs a method, for example, as described herein. Various embodiments are or include a method, system, or computer program, for example, for detecting leaks, wherein the method, system, or computer program, when operated, performs at least one combination or sub-combination of combinable limitations described herein. All combinations are contemplated.

Various methods may further include acts of obtaining, providing, assembling, or making various components described herein or known in the art. Various methods in accordance with different embodiments include acts of selecting, making, positioning, assembling, or using certain components, as examples. Other embodiments may include performing other of these acts on the same or different components, or may include fabricating, assembling, obtaining, providing, ordering, receiving, shipping, or selling such components, or other components described herein or known in the art, as other examples. Further, various embodiments include various combinations of the components, features, and acts described herein or shown in the drawings, for example. Other embodiments may be apparent to a person of ordinary skill in the art having studied this document.

What is claimed is:

1. A computer-implemented method of detecting leaks in a pipeline that transports oil, the method comprising:
using software for detecting leaks from the pipeline wherein: the pipeline can be changed without reconfiguring the software; and using the software comprises:
using data from sensors that watch the pipeline;
using different layers within the software, each of the different layers comprising deep learning;
monitoring multiple device types, each with its own deep learning neural network;
comparing with a parent deep learning neural network several deep learning layers to determine if there is a leak, with the computer looking at the several deep learning layers at one time;
using a metamodel to compare data to deep learning results;
using line balance to predict a line output;
using pressure and monitoring for pressure changes;
using flow and monitoring for flow changes;
using temperature to improve line balance accuracy;
using density to differentiate between crude types;
using valve position to monitor for changes;
using pump rpm or motor frequency to monitor for changes;
using event tags to determine outages or learn device average data frequency or to determine device communication issues;
considering meter maintenance or calibration;
considering recurrent communication issues with devices not associated with a field outage; and
conducting analysis of device data averages to determine anomalies.

2. The method of claim 1 further comprising using unsupervised learning wherein deep learning models are able to learn changes to the pipeline system without programing changes.

3. The method of claim 1 comprising:
a live version that monitors for leaks in real time; and
a history version that reruns data through deep learning models through multiple layers when looking into leaks to see what is causing an alarm.

4. The method of claim 1 further comprising graphically providing controller feedback on false positives.

5. The method of claim 1 further comprising determining size, duration, and location of a leak.

6. The method of claim 1 further comprising monitoring electrical power or current.

7. The method of claim 6 further comprising:
using unsupervised learning wherein deep learning models are able to learn changes to the pipeline system without programing changes;
a live version that monitors for leaks in real time;
a history version that reruns data through deep learning models through multiple layers when looking into leaks to see what is causing an alarm;
graphically providing controller feedback on false positives; and
determining size, duration, and location of a leak.
